(19) United States
(12) Patent Application Publication
(10) Pub. No.: US 2012/0023762 A1
(43) Pub. Date: Feb. 2, 2012

(54) HANDLE FOR BLADED HAND TOOL AND RAZOR

(75) Inventor: Tatsuya FURUTA, Seki-shi (JP)

(73) Assignee: KAI R&D CENTER CO., LTD, Gifu-ken (JP)

(21) Appl. No.: 13/188,694

(22) Filed: Jul. 22, 2011

(30) Foreign Application Priority Data
Jul. 27, 2010 (JP) 2010-168085

(51) Int. Cl. B26B 21/52; B25G 1/10

(52) U.S. Cl. 30/526; 30/340

(57) ABSTRACT

A space is provided in a front section of a handle. The space is located between side sections and extends along the longitudinal direction of a grip portion. A finger rest wall extending along the longitudinal direction is provided on each side section. The finger rest walls are provided to sandwich the space in the widthwise direction of the grip portion. Each finger rest wall is formed like a cantilever such that one of the ends in the thickness direction of the grip portion is a free end, and the other end is a fixed end. The space is opened between the free ends of the finger rest walls. The finger rest walls are attached to the side frame sections at the fixed ends. The side frame sections are formed of a material that is harder than the finger rest portion. The finger rest walls are deformed into the space when pressed toward the space.

### BACKGROUND OF THE INVENTION

The present invention relates to a handle for a bladed hand tool and a razor.

Conventionally, Japanese Laid-Open Patent Publication No. 2010-64170 discloses the structure of a handle for a bladed hand tool. According to the structure disclosed by the document, the surface of the handle includes, in addition to a part formed of hard resin, an exposed part formed of soft resin. When one's fingers are pressed against the handle surface to hold the handle, the disclosed structure is not likely to provide changes in gripping sensation.

### SUMMARY OF THE INVENTION

Accordingly, it is an objective of the present invention to improve the sensation experienced when one's fingers are pressed against the surface of a handle, such as a handle for bladed hand tool such as razor, to grip the hand tool.

To achieve the foregoing objective and in accordance with one aspect of the present invention, a handle for a bladed hand tool is provided that includes a grip portion and a pair of finger rest portions. The grip portion is held by a user and includes two side sections. The finger rest portions are provided on both side sections of the grip portion with respect to a widthwise direction, and extend along a longitudinal direction of the grip portion. Each finger rest portion is divided into a plurality of sections along the thickness direction of the grip portion, and different sections of the finger rest portions are displaced by different amounts when one of the finger rest portions is pressed toward the other to cause the finger rest portions to approach each other.

In accordance with another aspect of the present invention, a handle for a bladed hand tool is provided that includes a grip portion. The grip portion is held by a user and includes two end portions. A top portion is provided at one of the two end portions of the grip portion in the longitudinal direction, and a tail portion is provided at the other end portion. The razor head incorporating a blade set is attached to the top portion. The grip portion has a front section located on a side in which the edge of the blade body faces, a back section on a side opposite to the front section, and side sections on both sides in the widthwise direction and between the top portion and the tail portion. The front section has a space that is located between the side sections and extends along the longitudinal direction of the grip portion. Each side section has a finger rest portion. The finger rest portions sandwich the space along the widthwise direction and extending along the longitudinal direction. Each finger rest portion is formed like a cantilever such that one of the end portions in the thickness direction of the grip portion is a free end, and the other end is a fixed end. The space is opened between the free ends of the finger rest portions. The finger rest portions are attached, at the fixed ends, to the base portion of the grip portion. The base portion is formed of a material that is harder than the finger rest portion. The finger rest portions are flexed into the space when pressed toward the space, and at the flex, the amount of flex increases from the fixed end toward the free end.

### BRIEF DESCRIPTION OF THE DRAWINGS

FIG. 1A is a front perspective view illustrating a razor according to one embodiment of the present invention;

FIG. 1B is a rear perspective view illustrating the razor;

FIG. 2A is a front view illustrating the handle of the razor;

FIG. 2B is a rear view illustrating the handle of the razor;

FIG. 3A is a side view illustrating the razor;

FIG. 3B is a longitudinal cross-sectional view illustrating the razor;

FIG. 4A is a cross-sectional view taken along line 4A-4A in FIG. 3A; and

FIG. 4B is a cross-sectional view taken along line 4B-4B of FIG. 3A.

### DETAILED DESCRIPTION OF THE PREFERRED EMBODIMENTS

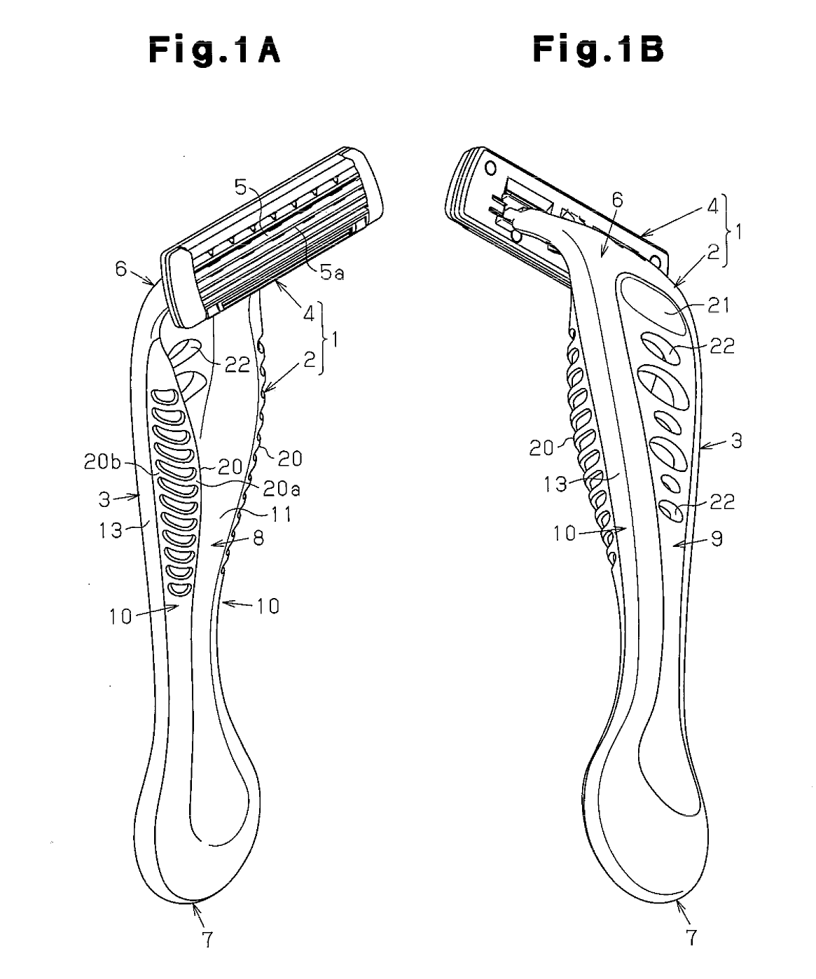

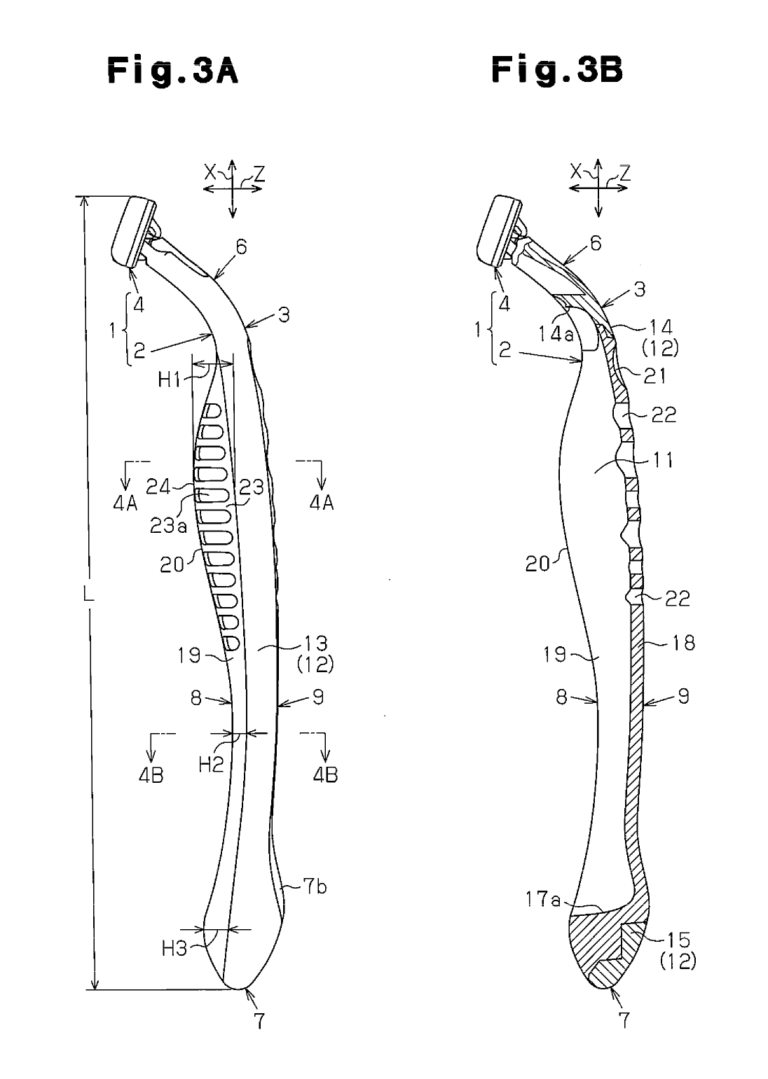

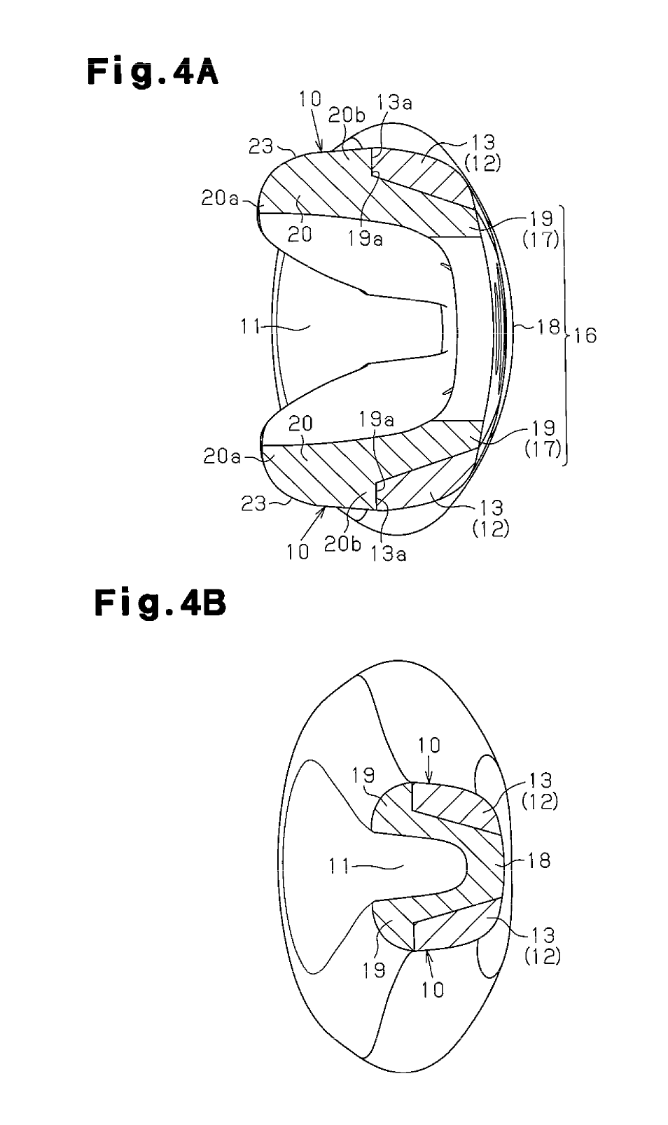

Hereinafter, a bladed tool according to one embodiment of the present embodiment will now be described with reference to FIGS. 1 to 4B. In the present embodiment, the bladed tool is a razor handle. When describing the bladed hand tool according to the present embodiment, the longitudinal direction X of a grip portion of the handle is referred to as an up-down direction. The widthwise direction Y of the grip portion is referred to as a left-right direction. The direction Z along the thickness of the grip portion is referred to as a front rear direction. Further, the direction in which the edge of razor head faces is referred to as a forward direction.

As shown in FIG. 1, a razor 1 includes a handle 2 and a razor head 4. The handle 2 includes a grip portion 3, a top portion 6, and a tail portion 7. A blade set 5 is incorporated in the razor head 4. The top portion 6 is provided at the upper end of the grip portion 3, and the tail portion 7 is provided at the lower end of the grip portion 3. The razor head 4 is attached to the handle 2 in the vicinity of the top portion 6. The razor head 4 cannot be detached from the handle 2 and is supported to be swingable. The grip portion 3 includes a front section 8 facing forward, a back section 9 facing rearward, and a pair of side sections 10 facing leftward and rightward. The side sections 10 are provided between the top portion 6 and the tail portion 7. The front section 8 has a space 11 defined between the side sections 10. The space 11 extends along the longitudinal direction X from the top portion 6 to the tail portion 7.

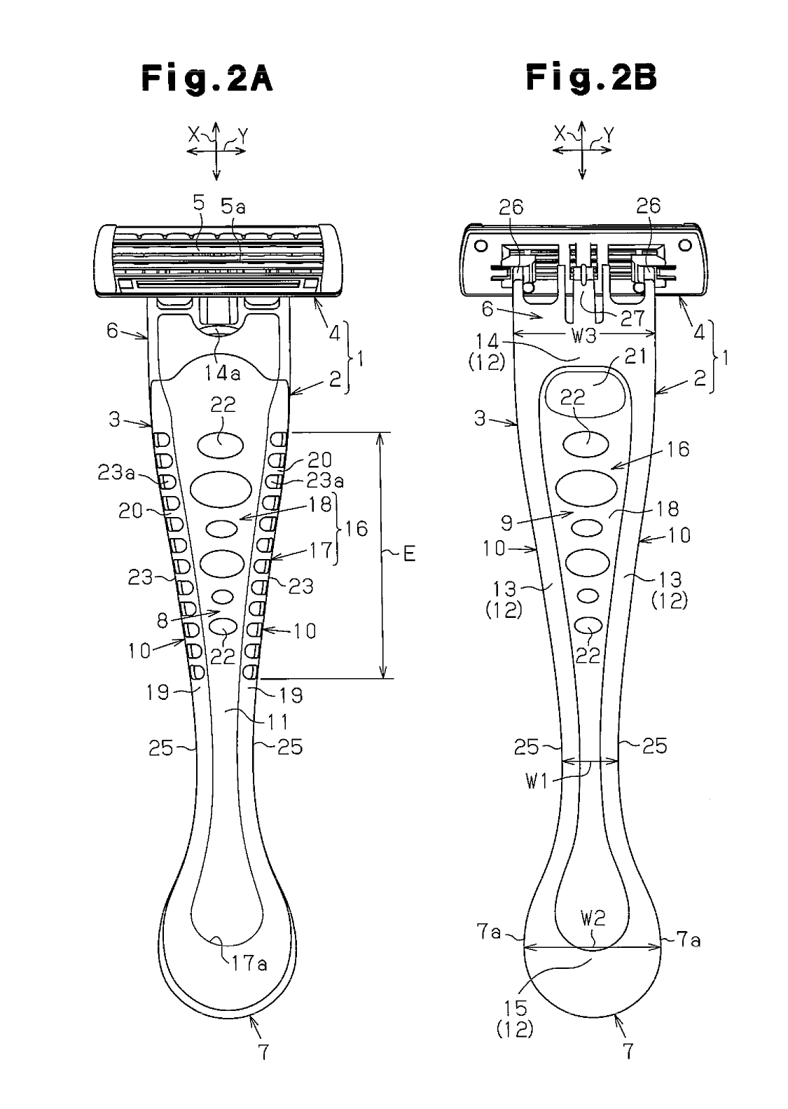

As shown in FIGS. 2 to 4, the grip portion 3 includes an annular support frame 12 and a wall 16 integrated with the support frame 12. The support frame 12 is formed by a pair of side frame sections 13 (base portions) forming the side sections 10, an end frame section 14 connecting the upper ends of the side frame sections 13, and an end frame section 15 connecting the lower ends of the side frame sections 13. The wall 16 has a peripheral wall section 17 and a back wall section 18 located inside the peripheral wall section 17. The peripheral wall section 17 substantially extends as a loop along the side frame sections 13 and the end frame sections 14, 15. The back wall section 18 is formed to be continuous to the peripheral wall section 17. The space 11 is surrounded by the peripheral wall section 17 and the back wall section 18. The space 11 is substantially closed by the back section 9 and opens forward. The support frame 12 is formed of a hard resin such as an ABS resin and a polypropylene resin. The wall 16 is formed of a soft resin such as an elastomer resin and a silicone resin. The hardness of the wall 16 is less than that of the support frame 12. The hardness of the wall 16 is preferably shore A30 to shore D60.

The peripheral wall section 17 includes a pair of side walls 19. The side walls 19 project forward from parts of the support frame 12 in the vicinity of the side frame sections 13. The side walls 19 each have a finger rest wall 20 serving as a finger rest portion. A pair of the finger rest walls 20 is provided to sandwich the space 11 from left and right. The finger rest walls 20 extend from the top portion 6 to the tail portion 7 along the longitudinal direction X. A single finger rest recess 21 and a plurality of through holes 22 are formed on the back wall section 18. The through holes 22 include larger holes and smaller holes. The finger rest recess 21 is formed adjacent to the frame end section 14 of the support frame 12, and the through holes 22 are formed adjacent to the finger rest recess 21. The larger holes and the smaller holes of the through holes 22 are arranged alternately. The through holes 22 remind the user of an image of bubbles in water. The side walls 19 each have a step 19a at the joint between the side wall 19 and the support frame 12 of the corresponding side frame section 13. The steps 19a of the side walls 19 are heat welded to end faces 13a of the side frame sections 13.

Each finger rest wall 20 is formed like a cantilever. The front end of each finger rest wall 20 is a free end 20a, and the rear end of each finger rest wall 20 is a fixed end 20b. The finger rest walls 20 are attached to the side frame sections 13 at the fixed ends 20b. The space 11 is open between the free ends 20a of the finger rest walls 20. Each finger rest wall 20 has an inner surface facing the space 11 and an outer surface 23 on the opposite side to the space 11. The outer surfaces 23 of the finger rest walls 20 approach each other from the fixed ends 20b toward the free ends 20a. Also, the free ends 20a of the finger rest walls 20 approach each other from the top portion 6 toward the tail portion 7. Nonslip sections 23a, which are formed by an uneven surface, are arranged along the longitudinal direction X on the outer surface 23 of each finger rest wall 20. Between the finger rest walls 20, the through holes 22 are located at positions corresponding to the nonslip sections 23a (in range E shown in FIG. 2A). Each outer surface 23 has an apex 24 in an intermediate portion between the top portion 6 and the tail portion 7. At the apex 24, the distance between the fixed end 20b and the free end 20a on the outer surface 23, that is, the measurement H1 of the outer surface 23 along the direction Z of the thickness is the maximum, which is approximately 7 mm. The measurement H1 of the outer surface 23 along the thickness direction Z gently changes toward the apex 24 from the top portion 6 and the tail portion 7. The finger rest walls 20 are flexed by being pushed toward the space 11. The amount of flex of the finger rest walls 20 increases from the fixed end 20b toward the free end 20a.

A constricted part 25 exists between a part of each side section 10 that forms the finger rest wall 20 and a part of the side section 10 that forms the tail portion 7. At the constricted parts 25, the measurement W1 in the widthwise direction Y of the handle 2, that is, the distance between the side sections 10, is the minimum, which is approximately 9 mm. The tail portion 7 is formed to be continuous to the constricted parts 25. The tail portion 7 has a swell portion 7a that bulges in each of the forward, rearward, leftward, and rightward directions. The measurement W2 of the swell portion 7a in the widthwise direction Y is approximately 22 mm. The tail portion 7 has a projection 7b, which slightly bulges in the direction Z of thickness of the back wall section 18. The constricted parts 25 allow the grip portion 3 to be elastically deformed. Specifically, the constricted parts 25 allow the grip portion 3 to be flexed in a first direction, or along a line connecting the front section 8 and the back section 9 to each other, and in a second direction, or along a line connecting the side sections 10 to each other. The constricted parts 25 also allow the grip portion 3 to be twisted along a circumferential direction including the front section 8, the back section 9, and the side sections 10. In other words, the grip portion 3 is flexed in the thickness direction Z, which corresponds to the first direction, and the widthwise direction Y, which corresponds to the second direction, and twisted about an axis extending along the longitudinal direction X.

The measurement of the outer surfaces 23 along the thickness direction Z decreases from the apexes 24 toward the constricted parts 25. At the constricted parts 25, the outer surfaces 23 of the finger rest walls 20 are gently continuous to the outer surfaces of the side walls 19. At the constricted parts 25, the measurement H2 of the outer surface of each side wall 19 along the thickness direction Z is the minimum, which is approximately 2 mm. The measurement H3 of the outer surface of each side wall 19 along the thickness direction Z gradually increases from the constricted part 25 toward the tail portion 7 and reaches approximately 3.5 mm. The lower end of the space 11 extends to the swell portion 7a of the tail portion 7. A finger catch 17a, on which a finger can be placed, is formed at the lower end of the peripheral wall section 17. The lower end of the peripheral wall section 17 forms the lower end of the space 11.

The frame end section 14 of the support frame 12 is used as a support portion that supports the razor head 4 to the handle 2. At the frame end section 14, the measurement W3 of the handle 2 in the widthwise direction Y is the maximum, which is approximately 23 mm. A support arm 26 is provided at each of the left and right ends of the frame end section 14. The razor head 4 is pivotably supported at the upper end of the handle 2 with the pair of support arms 26. A leaf spring 27 is provided at the center in the end frame section 14 in the widthwise direction Y. The razor head 4 is elastically urged by the leaf spring 27. Specifically, the razor head 4 can be tilted rearward against the elastic force of the leaf spring 27 from a stationary position, in which the razor head 4 is urged forward by the elastic force of the leaf spring 27. The space 11 is opened toward the end frame section 14. The space 11 opens toward the razor head 4 through left and right sides of a small projection 14a of the frame end section 14. The total length L of the razor 1 is approximately 130 mm.

When the handle 2 is held, the pulp of a user's thumb and the pulp of the user's index finger are pressed against the finger rest walls 20. Alternatively, the pulp of the index finger is pressed against the finger rest recess 21 of the back section 9, and the pulps of the thumb and middle finger are pressed against the finger rest walls 20. In this state, the projection 7b of the tail portion 7 is pressed against the palm, and the swell portion 7a of the tail portion 7 is wrapped with the palm. Further, in this state, the little finger or ring finger is pressed against the finger catch 17a of the tail portion 7 via the space 11. In this manner, by wrapping the swell portion 7a of the tail portion 7 with the palm, the tail portion 7 is stably held. Also, if the handle 2 is held with the thumb, index finger, or middle finger, the top portion 6 can be displaced by flexing the constricted parts 25.

The present embodiment provides the following advantages.

(1) Each finger rest wall 20 is divided into sections along the thickness direction Z of the grip portion 3, and the amount of displacement of the finger rest wall 20 varies depending on which section of the section 20 is pressed. That is, when a finger is pressed against the finger rest walls 20 while the handle 2 is held, the amount of displacement (the amount of flex) increases from the fixed end 20b toward the free end 20a. This allows the handle 2 to fit a user's hand or fingers. Accordingly, sensation experienced when the grip portion 3 is held and fingers are pressed against the finger rest walls 20 is improved. Particularly, if the razor 1 is a wet type, the handle 2 is stably held even when the handle 2 is wet and slippery. Also, since the handle 2 has the space 11 in the front section 8, the finger rest walls 20 are easily deformed. Therefore, the fitting when the fingers are pressed against the finger rest walls 20 is further improved, and the feel is improved.

(2) The grip portion 3 can be elastically deformed at the constricted parts 25. Specifically, the constricted parts 25 allow the grip portion 3 to be flexed in a first direction, or along a line connecting the front section 8 and the back section 9 to each other, and in a second direction, or along a line connecting the side sections 10 to each other. The constricted parts 25 also allow the grip portion 3 to be twisted along a circumferential direction including the front section 8, the back section 9, and the side sections 10. Therefore, when being held, the handle 2 can be deformed in accordance with the force applied thereto. This allows the handle 2 to be comfortably fit with a user's hand and fingers, thereby further improving sensation experienced when fingers are pressed against the finger rest walls 20.

(3) The side frame sections 13 are made of hard material. The side frame sections 13 therefore have rigidity. However, if the thickness is reduced, the side frame sections 13 are allowed to be flexed by external force. The side frame sections 13 can be flexed by pinching the back wall section 18, particularly, to cause the finger rest walls 20 to approach each other. At this, the rigidity of the handle 2 is maintained by the rigidity of the side frame sections 13. Since the finger rest walls 20 are more easily flexed than the side frame sections 13, the handle 2 can fit fingers of the user. The constricted parts 25 are made of hard material and soft material. Also, the distance between the side frame sections 13 is reduced at the constricted parts 25. Thus, the constricted parts 25 can be twisted or bent while maintaining certain rigidity.

(4) The through holes 22 are formed in the back wall section 18. Between the finger rest walls 20, the through holes 22 are located at positions corresponding to the nonslip sections 23a (in range E shown in FIG. 2A). Therefore, the through holes 22 allow the finger rest walls 20 to be easily flexed, so that the nonslip sections 23a can be held by fingertips. The handle 2 of the razor 1 is therefore easy to use.

The present embodiment may be modified as follows.

The back wall section 18 may be omitted from the wall 16. In this case, the space 11 may be opened forward and backward inside the peripheral wall section 17.

The space 11 may be omitted from the grip portion 3. In this case, to allow the finger rest walls 20 to be elastically deformable, the section in the grip portion 3 that corresponds to the space 11 may be filled with flexible material such as cotton or sponge.

When the front section 8, the back section 9, and the side sections 10 do not need to be distinguished from one another, the finger rest walls 20 and the space 11 may be provided in at least one of the back section 9 and the side sections 10, in addition to in the front section 8.

The amount of displacement when the finger rest walls 20 are pressed and deformed may be greater in a middle portion of the finger rest walls 20 with respect to the thickness direction Z than in the remainder.

The steps 19a of the side walls 19 are heat welded to the end faces 13a of the side frame sections 13. However, the steps 19a may be unstickable from the end face 13a of the side frame sections 13. In this case, using, as an index, unsticking of the side walls 19 from the side frame sections 13 due to frequent use of the razor, the handle 2 can be replaced at an appropriate time.

The razor head 4 may be fixed to the handle 2. Alternatively, the razor head 4 may be detachable from the handle 2, so that the razor head 4 is replaceable. Further, the razor head 4 does not necessarily need to be supported swingable relative to the handle 2.

Other than the razor 1, the present invention may be applied to the handle of any type of bladed hand tool, such as a graver, a cutter, scissors, nail clippers, a kitchen knife, a medical instrument (such as, a surgical knife).

1. A handle for a bladed hand tool, the handle comprising:
a grip portion for being held by a user, the grip portion including two side sections; and
a pair of finger rest portions provided on both side sections of the grip portion with respect to a widthwise direction, the finger rest portions extending along a longitudinal direction of the grip portion,
wherein each finger rest portion is divided into a plurality of sections along the thickness direction of the grip portion, and different sections of the finger rest portions are displaced by different amounts when one of the finger rest portions is pressed toward the other to cause the finger rest portions to approach each other.

2. The handle for a bladed hand tool according to claim 1, wherein
a space is provided in the grip portion, the space extending along the longitudinal direction of the grip portion and the finger rest portions having end portions,
the space is opened at least one of the end portions of the finger rest portions,
the finger rest portions are provided to sandwich the space along the widthwise direction, and
the finger rest portions are deformed into the space when pressed toward the space.

3. The handle for a bladed hand tool according to claim 2, wherein
each finger rest portion is formed like a cantilever such that one of the end portions in the thickness direction is a free end, and the other end portion is a fixed end,
the space is opened between the free ends of the finger rest portions,
the finger rest portions are attached, at the fixed ends, to the base portion of the grip portion, and
the base portion is formed of a material that is harder than the finger rest portion.

4. The handle for a bladed hand tool according to claim 1, wherein
the amount of displacement is an amount by which one of the finger rest portions is flexed when it is pressed toward the other finger rest portion, and
the end portions of each finger rest portion in the thickness direction are flexed by a greater extent than an intermediate section of the finger rest portion in the thickness direction.

5. The handle for a bladed hand tool according to claim 2, wherein
a top portion is provided at one of the two end portions of the grip portion in the longitudinal direction, and a tail portion is provided at the other end portion,
a razor head incorporating a blade set is attached to the top portion,
the grip portion has a front section located on a side in which the edge of the blade body faces, a back section on a side opposite to the front section, and side sections on both sides in the widthwise direction and between the top portion and the tail portion,
the space is formed in the front section and opens in the thickness direction, and
the finger rest portions are each provided on one of the side sections.

6. The handle for a bladed hand tool according to claim 5, wherein
the side sections extend along the longitudinal direction from the top portion to the tail portion,
a constricted part is provided between a part of each side section that forms a finger rest portion and a part of the side section that forms the tail portion,
at the constricted parts, the distance between the side sections is smaller than the distance in other sections, and
the constricted parts allow the grip portion to be deformed.

7. A handle for a bladed hand tool, the handle comprising:
a grip portion for being held by a user, the grip portion including two end portions, wherein
a top portion is provided at one of the two end portions of the grip portion in the longitudinal direction, and a tail portion is provided at the other end portion,
a razor head incorporating a blade set is attached to the top portion,
the grip portion has a front section located on a side in which the edge of the blade body faces, a back section on a side opposite to the front section, and side sections on both sides in the widthwise direction and between the top portion and the tail portion,
the front section has a space that is located between the side sections and extends along the longitudinal direction of the grip portion,
each side section has a finger rest portion, the finger rest portions sandwiching the space along the widthwise direction and extending along the longitudinal direction,
each finger rest portion is formed like a cantilever such that one of the end portions in the thickness direction of the grip portion is a free end, and the other end is a fixed end,
the space is opened between the free ends of the finger rest portions,
the finger rest portions are attached, at the fixed ends, to the base portion of the grip portion,
the base portion is formed of a material that is harder than the finger rest portion, and
the finger rest portions are flexed into the space when pressed toward the space, and at the flex, the amount of flex increases from the fixed end toward the free end.

8. The handle for a bladed hand tool according to claim 3, wherein
the base portion is a side frame section that extends between the end portions of the grip portion in the longitudinal direction and along the finger rest portion,
the grip portion includes a loop-like support frame, and
the support frame is formed by the side frame sections, an end frame section that connects end portions of the side frame sections on one end to each other, and an end frame section that connects end portions of the side frame section on the other end.

9. The handle for a bladed hand tool according to claim 3, wherein
a back wall section that faces the space is provided between the base portions, to which the fixed ends of the finger rest portions are attached, and
the back wall section is formed to be continuous to the finger rest portions.

10. The handle for a bladed hand tool according to claim 3, wherein
the finger rest portions each include an inner surface facing the space and an outer surface on the opposite side to the space, and
the outer surfaces of the finger rest portions approach each other from the fixed ends toward the free ends.

11. The handle for a bladed hand tool according to claim 3, wherein
the finger rest portions each include an inner surface facing the space and an outer surface on the opposite side to the space, and
the free ends of the finger rest portions approach each other from one of the ends of the grip portion in the longitudinal direction toward the other end.

12. The handle for a bladed hand tool according to claim 3, wherein
the finger rest portions each include an inner surface facing the space and an outer surface on the opposite side to the space, and
the distance between the fixed ends and the free ends becomes the maximum at an intermediate section between the ends of the grip portion in the longitudinal direction.

13. The handle for a bladed hand tool according to claim 5, wherein
a space is formed in the front section,
the space is located between the side sections and extends from the top portion to the tail portion, and
the side sections, which form the finger rest portions, sandwich a part of the space or the entire space.
